(19) United States
(12) Patent Application Publication
(10) Pub. No.: US 2025/0121629 A1
(43) Pub. Date: Apr. 17, 2025

(54) DEFORMABLE WHEEL WITH NON-PNEUMATIC LOAD BEARING AND WITH TREAD HEATING FOR LUNAR AND MARTIAN CONDITIONS

(71) Applicant: VENTURI LAB SA, CORMINBOEUF (CH)

(72) Inventors: David OLSOMMER, CORMINBOEUF (CH); Pascal SCHROETER, CORMINBOEUF (CH); Antonio DELFINO, CORMINBOEUF (CH); Gérard BAUMGARTNER, CORMINBOEUF (CH); Laurent SCHMUTZ, CORMINBOEUF (CH)

(21) Appl. No.: 18/909,090

(22) Filed: Oct. 8, 2024

(30) Foreign Application Priority Data
Oct. 12, 2023 (EP) 23203178

(51) Int. Cl. B60B 9/00; B64G 1/16

(52) U.S. Cl. CPC B60B 9/005; B64G 1/16

(57) ABSTRACT

Disclosed herein is a deformable wheel with non-pneumatic load bearing intended to equip a vehicle for driving in extreme conditions such as those encountered on the Moon and on Mars, comprising a hub, a laminated strip comprising a plurality of ferrules assembled with the interposition of interposition layers, and a plurality of metal cables connecting the hub to the laminated strip, the laminated strip being covered with at least one thermal insulation coating made of at least one material having a thermal conductivity of less than 0.2 Wm⁻¹K⁻¹, and the wheel further comprising means for heating the interposition layers of the laminated strip.

### RELATED APPLICATIONS/PRIORITY CLAIMS

This application claims priority to EP patent application Ser. No. 23/203,178 filed on Oct. 12, 2023, the contents of which are incorporated by reference herein.

### BACKGROUND

The present application relates to a non-pneumatic load-bearing deformable wheel. More particularly, the application relates to a wheel that bears a load with its structural components and that has performance capabilities suitable for equipping a vehicle intended to run in extreme conditions such as those encountered on the Moon and Mars.

The pneumatic wheel has load-bearing, road shock absorption, and force transmission (acceleration, stopping, and direction changes) capabilities that are particularly well suited to many vehicles, including bicycles, motorcycles, automobiles, and trucks. The shock absorption capabilities of pneumatic tires are also useful in other applications, such as carts carrying medical equipment or sensitive electronic material.

Alternatives to pneumatic wheels exist. Mention can for example be made of solid tires and spring-loaded tires. However, these alternatives do not have the performance advantages of pneumatic wheels. In particular, solid tires rely on the compression of the part in contact with the ground to bear the load. This type of tires can be heavy and stiff and does not have the shock absorption capabilities of pneumatic wheels. When made more elastic, conventional non-pneumatic wheels do not have the load bearing or endurance of pneumatic wheels.

To overcome these disadvantages, U.S. Pat. No. 7,418,988 provides a structurally supported tire that comprises an outer annular strip and a plurality of spokes extending transversely and radially inward from the annular strip to the wheel hub and intended to transmit in tension the load forces between the annular strip and the hub.

The structurally supported wheel of this application does not include a cavity intended for containing pressurized air and therefore does not need to have a seal with the wheel rim to maintain internal air pressure. This structurally supported wheel therefore does not require a tire in the sense that it is understood.

The spokes of this wheel act in tension to transmit load forces between the wheel and the annular strip, which in particular allows the mass of a vehicle to be borne. The bearing forces are generated by the tension of the spokes that are not connected to the part of the annular strip in contact with the ground. The spokes also transmit the forces required for acceleration, stopping and cornering.

Regardless of the alternatives known from the prior art for the production of non-pneumatic wheels, the latter are generally not entirely satisfactory, particularly when they are intended to run in extreme conditions such as those encountered on the Moon and Mars. Indeed, with such conditions, it is necessary for the wheel to be able to deform significantly when passing an obstacle while generating a contact pressure that is low and uniform to allow the vehicle to remain mobile on soft ground such as the ground encountered on the Moon and Mars.

Patent application EP22192685 filed on Aug. 29, 2022 by the Applicant discloses a wheel that allows to meet these needs, in particular due to the presence of a laminated annular strip that comprises a plurality of concentric ferrules that are assembled with the interposition of interposition layers each composed of a material the Young's modulus of which is 600000 to 1000 times lower than that of the ferrules, for example made of elastomeric material. Under a load applied from the outside, the part of the laminated strip in contact with the ground deforms, not in an essentially circular shape, but in a shape that matches the surface of the ground while maintaining an essentially constant length of the ferrules. The wheel according to this patent application thus allows to generate a contact pressure that is low and uniform on the ground. In this way, the vehicle equipped with such wheels can remain mobile (that is to say it does not get stuck in the sand) even on soft ground (such as sand) such as that encountered on the Moon and Mars.

The elastomer-based structure of the interposition layers of the laminated strip of such a wheel has a minimum operating temperature between −140° C. and −150° C., which allows the wheel to operate, on the one hand, in most missions around the lunar south pole and on the other hand to operate at all latitudes on Mars (where the absolute minimum temperature is −120° C.). However, such a limit can pose problems if the vehicle equipped with such wheels has to travel to permanently shadowed regions (or PSR) such as the lunar poles for which temperatures are permanently in the order of −220° C. to −240° C.

### SUMMARY

The main purpose of the present application is to overcome such disadvantages by proposing a deformable wheel structure with non-pneumatic load bearing which can equip vehicles intended to travel in permanently shadowed regions of the Moon where temperatures are permanently of the order of −220° C. to −240° C.

In accordance with the application, this purpose is achieved by means of a deformable wheel with non-pneumatic load bearing intended to equip a vehicle for driving in extreme conditions such as those encountered on the Moon and on Mars, comprising:
a hub,
a laminated annular strip intended to be in contact with the ground, positioned around the hub which is concentric therewith and comprising a plurality of concentric ferrules that are assembled with the interposition of interposition layers each composed of a material the Young's modulus of which is 600000 to 1000 times lower than that of the ferrules, and
a plurality of metal cables radially connecting the hub to the laminated strip while being fastened, on the one hand by an outer end to the laminated strip, and on the other hand by an inner end to the hub,
and in which, in accordance with the application:
the laminated strip is covered with at least one thermal insulation coating made of at least one material having a thermal conductivity of less than 0.2 Wm⁻¹K⁻¹, and
the wheel further comprises means for heating the interposition layers of the laminated strip.

The wheel according to the application is remarkable in particular due to the use of means for heating the interposition layers of the laminated strip allowing to deviate the temperature of these interposition layers away from the glass transition temperature of the material that composes them. Given that the material composing these interposition layers tends to self-generate heat when it deforms when running (due to a running resistance), and that the heat generated is even higher as the temperature of the material approaches its glass transition temperature, this will have the effect of heating the wheel more to deviate it even further away from this glass transition temperature.

Moreover, the presence of a thermal insulation coating at the laminated strip allows to limit the thermal conductivity between the Lunar ground and the material making up the interposition layers of the laminated strip.

As a result, the wheel according to the application is capable of withstanding temperatures of the order of −220° C. to −240° C. which are typically encountered in regions of the Moon which are permanently in the shadow.

The means for heating the laminated strip may comprise rotating contacts for establishing a rotating electrical connection between the wheel hub and the ferrules of the laminated strip.

In this case, the rotating contacts are preferably coupled to electric heating wires which are wound in the thickness of the ferrules of the laminated strip.

More specifically, the ferrules of the laminated strip can be made of composite material and the interposition layers can be composed of a hyperelastic elastomer, the electric wires of the heating means of the laminated strip being embedded in the composite material during the manufacture of the ferrules in order to convey calories to the elastomer making up the interposition layers.

In this case, the electric wires are advantageously positioned at a neutral fiber in the circumferential direction of the composite material in a plurality of loops circumferentially spaced from each other.

Preferably, the electric heating wires run inside a spring, one end of which is screwed on the side of the laminated strip onto a collar fastened to a ferrule of the laminated strip containing the electric heating wire, and an opposite end is fastened to the hub.

The thermal insulation coating can be made of one or more of the following materials: synthetic aramid fiber, fiberglass, polyvinyl acetate, and leather.

Preferably, the thermal insulation coating is covered under an internal face with a metallic coating to limit the transfer of thermal energy by radiation.

Also preferably, the wheel further comprises means for measuring the temperature of the interposition layers of the laminated strip.

More preferably, the wheel further comprises means for measuring the deformations and stresses of the laminated strip in order to monitor the performance and the service life of the laminated strip to compensate for any failure in the event of a mission far from a lunar base.

### BRIEF DESCRIPTION OF THE DRAWINGS

Other features and advantages of the present application will emerge from the description given below, with reference to the appended drawings which illustrate an exemplary embodiment thereof without any limiting character. In the figures:

FIG. 1 is a schematic and perspective view of a wheel according to one embodiment of the application;

FIG. 2 is a schematic and front view of the wheel of FIG. 1 in elevation;

FIG. 3 is a sectional view along III-III of FIG. 2; and

FIG. 4 shows an example of a ferrule of the laminated strip of the wheel in which electric heating wires are embedded.

FIG. 5 is a view of part of the spring inside which the electric wires heating interposition layers of the laminated strip run.

### DETAILED DESCRIPTION OF EMBODIMENTS

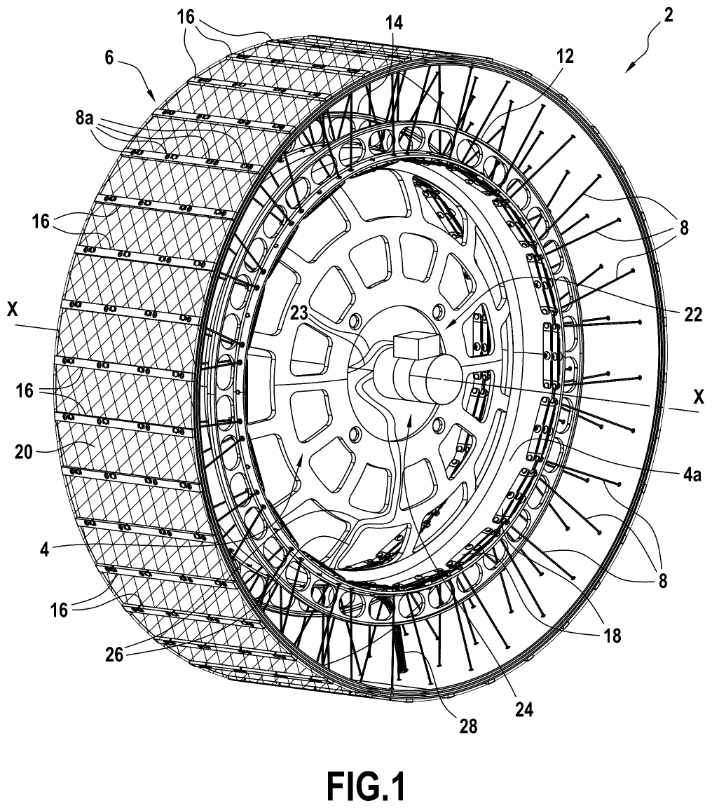

The application relates to a deformable wheel with non-pneumatic load bearing as shown in FIG. 1 which is suitable for equipping a vehicle intended to run in extreme conditions such as those encountered on the Moon and on Mars.

The wheel 2 shown in FIG. 1 mainly comprises a hub 4, a laminated annular strip 6 intended to be in contact with the ground, and a plurality of metal cables 8 radially connecting the hub to the laminated strip.

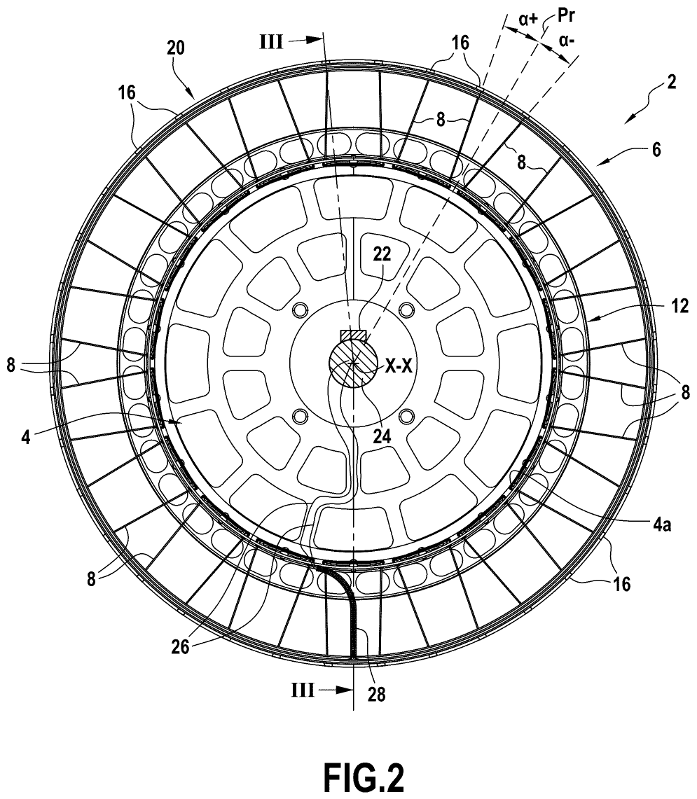

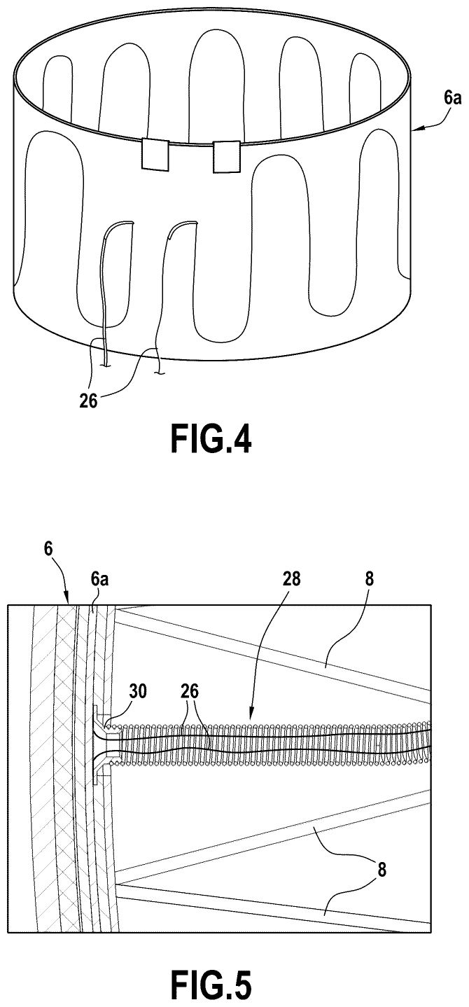

As shown in FIGS. 2 and 4, the laminated strip 6 is composed of a plurality of concentric ferrules 6a which are assembled together by sandwiching interposition layers 6b each composed of a material the Young's modulus of which is 600000 to 1000 times lower than that of the ferrules.

The ferrules 6a may be metallic (for example made of steel) or made of composite material.

As for the interposition layers 6b, they are advantageously made of a hyperelastic elastomer having a glass transition temperature of less than 120° C.

By such a composition of the laminated strip 6, the part of the laminated strip which is in contact with the ground deforms under a load applied from the outside but in a shape which matches the surface of the ground while maintaining an essentially constant length of the ferrules 6a which compose it. The relative movement of the ferrules of the laminated strip occurs by shearing in the interposition layers 6b.

As shown in particular in FIG. 1, the hub 4 of the wheel carries two disks 12, 14 which project radially outwards. These two disks 12, 14 are spaced from each other along the axis X-X of the wheel and each have an external diameter against which the internal surface of the laminated strip 6 is able to abut in order to limit the deformations thereof.

The cables 8 radially connect the laminated strip 6 to the hub 4. For this purpose, each cable 8 comprises an outer end 8a which is fastened to rods 16 themselves mounted against an outer surface of the laminated strip.

In this configuration, the outer ends 8a of the cables pass through all the ferrules 6a and interposition layers 6b of the laminated strip. Of course, it is possible to consider that the outer ends 8a of the cables are fastened on the inner surface of the laminated strip.

At their respective inner ends, the cables 8 are fastened to the hub 4 preferably by means of an elastic member 18 allowing to modulate the radial stiffness of the cables. Here too, the inner ends 8b of the cables pass through the hub in its thickness.

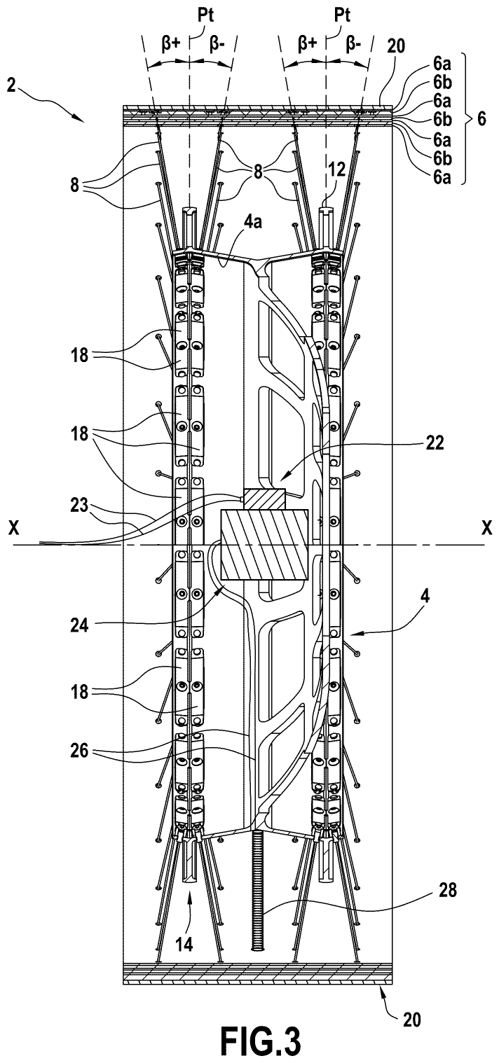

In the embodiment of FIGS. 1 to 3, the elastic members 18 are leaf springs which each have the shape of an elongated plate and which are fastened at their center by rivets against an inner surface 4a of the hub.

In another embodiment not shown in the figures (but described in patent application EP22192685), the elastic members may be in the form of blades folded into a U (that is to say at 180°) forming springs allowing to modulate the radial stiffness of the cables.

Each cable 8 is composed of an assembly of metal wires (for example made of steel) made up of strands, themselves assembled around a metal core. For example, each cable includes 6 or 7 strands each composed of 7 to 61 metal wires, the assembly having an external diameter comprised between 0.2 mm and 5 mm.

In addition, each cable 8 can advantageously have a ratio between its mechanical stiffness in tension Kt and its mechanical stiffness in compression Kc which is comprised between 50000 and 300000 (that is to say 5000≤Kt/Kc≤300000), and preferably comprised between 25000 and 150000 (that is to say 25000≤Kt/Kc≤150000).

These mechanical stiffness values Kt and Kc were obtained by following the recommendations of the ISO 2408:2017 and ISO 17893:2004 standards (relating to the requirements of steel cables) and by using a testing machine of the brand “INSTRON®”, model 34TM-10.

In other words, the cables 8 have a stiffness asymmetry with a mechanical stiffness in tension Kt which is significantly greater than their mechanical stiffness in compression Kc.

Moreover, in the embodiment of the figure, the cables 8 have a particular distribution all around the axis X-X of the wheel with a first double row of n cables the respective inner ends of which are positioned on the inner side of the wheel, and a second double row of m cables the respective inner ends of which are positioned on the outer side of the wheel.

More specifically, for each double row of cables, the inner ends are mounted on the hub by being positioned laterally between one of the two disks 12, 14 and the lateral (internal and external) edge of the hub. The number n, m of cables can be the same for each double row of cables.

In addition, as shown in FIG. 2, each cable 8 is advantageously inclined relative to a plane Pr radial to the hub 4 by an angle α comprised (in absolute value) between 0.1° and 45°, and preferably equal to 10° (in absolute value).

In particular, for the same row of cables, it may be advantageous to provide for alternating inclinations between adjacent cables (one of the cables would have a positive inclination angle α− noted “α+” in FIG. 2—and the adjacent cable would have a negative inclination angle α− noted “α−” in FIG. 2).

Similarly, as shown in FIG. 4, each cable 8 is advantageously inclined relative to a plane Pt transverse to the hub 4 by an angle β comprised between 0.1° and 45° (in absolute value), and preferably equal to 10° (in absolute value).

In particular, for each of the two double rows of cables, it may be advantageous to provide that all the cables belonging to one of the two rows have a positive inclination angle β (denoted “β+” in FIG. 4) and all cables belonging to the other of the two rows have a negative inclination angle β (denoted “β−” in FIG. 4).

These inclinations α, β of the cables 8 allow to increase the rigidity of the wheel when it is stressed laterally (for example in a bend) or when the vehicle equipped with such a wheel brakes.

The laminated strip 6 of the wheel 2 may be covered with at least one thermal insulation coating 20 which is made of at least one material having a thermal conductivity of less than 0.2 Wm⁻¹K⁻¹, that is to say very low.

For example, this thermal insulation coating 20 can be made from one or more of the following materials: synthetic aramid fiber (in particular Kevlar®), fiberglass, polyvinyl acetate, and leather.

Moreover, in order to further reduce the effective thermal conductivity of the thermal insulation coating, it is advantageous to provide it with “pockets” or vacuum openings on the inside. This is achieved, for example, by means of a woven material.

In addition, the thermal insulation coating 20 can be made by assembling several materials, in particular by stacking several layers of different materials. For example, the thermal insulation coating 20 can be made by stacking a 3 to 5 mm thick layer of leather, a layer of aluminum to limit radiation, a 5 to 10 mm thick layer of aramid fabric, and a 1 to 2 mm thick layer of polyvinyl acetate.

More generally, the thermal insulation coating 20 is advantageously covered under an internal face with a metallic coating (for example a layer of aluminum) to limit the transfer of thermal energy by radiation.

The wheel 2 further may comprise means for heating the interposition layers 6b of the laminated strip.

These means for heating the interposition layers 6b of the laminated strip may comprise rotating contacts for establishing a rotating electrical connection between the hub 4 of the wheel and the ferrules 6a of the laminated strip.

FIG. 2 shows an example of implementation of such rotating contacts: a block of brushes 22 is secured to the vehicle equipped with the wheel 2 and supplied with electricity from the latter via power cables 23. This block of brushes 22 is in electrical contact with a ring 24 centered on the axis X-X of the wheel and secured to the hub 4 thereof in order to ensure a transfer of the electrical power supply to the ferrules 6a of the laminated strip via electric heating wires 26 which are wound in the thickness of the ferrules 6a of the laminated strip.

Advantageously, as shown in FIG. 4, when the ferrules 6a of the laminated strip are made of composite material and the interposition layers 6b are composed of a hyperelastic elastomer, the electric heating wires 26 can be embedded in the composite material of one of the ferrules when manufactured in order to convey calories to the hyperelastic elastomer making up the interposition layers 6b.

In this case, the electric heating wires 26 are preferably positioned at a neutral fiber in the circumferential direction (that is to say the fiber which does not undergo any variation in length, regardless of the bending deformation of the ferrule) of the composite material in a plurality of loops 26a which are circumferentially spaced from each other.

Moreover, as shown in detail in FIG. 5, the electric heating wires 26 can advantageously run inside a spring 28, one end of which is screwed on the side of the laminated strip onto a collar 30 itself fastened to the ferrule 6a of the laminated strip containing the electric heating wire, and an opposite end which is fastened to the hub.

The use of such a spring to route the electric heating wires has many advantages, in particular that of being able to guarantee the protection of the wires against possible contact with stones, and of allowing a movement of several centimeters between the hub and the laminated strip.

According to another advantageous arrangement (not shown in the figures), means for measuring the temperature (for example thermocouples or other sensors of different types) of the interposition layers 6b of the laminated strip may be provided in order to control the heating power to be conveyed thereto to prevent their temperature from approaching the glass transition temperature of the material of which they are composed.

For example, the temperature of the interposition layers 6b of the laminated strip can be monitored using Bragg grating optical fibers (known per se) which are directly inserted into the thickness of the ferrules 6a.

The advantage of using Bragg grating optical fibers is that they also allow deformations to be monitored and the stresses undergone by the material making up the ferrules of the laminated strip to be deduced.

Alternatively, monitoring the temperature of the interposition layers 6b of the laminated strip can be achieved by means of a temperature probe, for example a platinum resistance thermometer (also called RTD probe for “Resistance Temperature Detector”).

According to yet another advantageous arrangement (not shown in the figures), means may be provided for measuring the deformations and stresses of the laminated strip, for example using Bragg grating optical fibers.

It will be noted that the means for measuring the temperature of the interposition layers of the laminated strip and the means for measuring the deformations and stresses of the laminated strip can advantageously pass through the spring used to route the electric heating wires.

1. A deformable wheel with non-pneumatic load bearing intended to equip a vehicle for driving in extreme conditions such as those encountered on the Moon and on Mars, the deformable wheel comprising:
a hub;
a laminated annular strip intended to be in contact with the ground, positioned around the hub which is concentric therewith and comprising a plurality of concentric ferrules that are assembled with the interposition of interposition layers each composed of a material the Young's modulus of which is 600000 to 1000 times lower than that of the ferrules; and
a plurality of metal cables radially connecting the hub to the laminated strip while being fastened, on the one hand by an outer end to the laminated strip, and on the other hand by an inner end to the hub;
wherein the laminated strip is covered with at least one thermal insulation coating made of at least one material having a thermal conductivity of less than 0.2 Wm⁻¹K⁻¹;
wherein the wheel further comprises means for heating the interposition layers of the laminated strip.

2. The wheel according to claim 1, wherein the means for heating the laminated strip comprise rotating contacts for establishing a rotating electrical connection between the hub of the wheel and the ferrules of the laminated strip.

3. The wheel according to claim 2, wherein the rotating contacts are coupled to electric heating wires which are wound in the thickness of the ferrules of the laminated strip.

4. The wheel according to claim 3, wherein the ferrules of the laminated strip are made of composite material and the interposition layers are composed of a hyperelastic elastomer, the electric heating wires of the heating means of the laminated strip being embedded in the composite material during the manufacture of the ferrules in order to convey calories to the elastomer making up the interposition layers.

5. The wheel according to claim 4, wherein the electric wires are positioned at a neutral fiber in the circumferential direction of the composite material in a plurality of loops circumferentially spaced from each other.

6. The wheel according to claim 3, wherein the electric heating wires run inside a spring one end of which is screwed on the side of the laminated strip onto a collar fastened to a ferrule of the laminated strip containing the electric heating wire, and an opposite end is fastened to the hub.

7. The wheel according to claim 1, wherein the thermal insulation coating is made of one or more of the following materials: synthetic aramid fiber, fiberglass, polyvinyl acetate, and leather.

8. The wheel according to claim 1, wherein the thermal insulation coating is covered under an internal face with a metallic coating to limit the transfer of thermal energy by radiation.

9. The wheel according to claim 1, further comprising means for measuring the temperature of the interposition layers of the laminated strip.

10. The wheel according to claim 1, further comprising means for measuring the deformations and stresses of the laminated strip.

11. A deformable wheel with non-pneumatic load bearing, the deformable wheel comprising:
a hub;
a laminated annular strip intended to be in contact with the ground, positioned around the hub which is concentric therewith and comprising a plurality of concentric ferrules that are assembled with the interposition of interposition layers each composed of a material the Young's modulus of which is 600000 to 1000 times lower than that of the ferrules; and
a plurality of metal cables radially connecting the hub to the laminated strip while being fastened, on the one hand by an outer end to the laminated strip, and on the other hand by an inner end to the hub;
wherein the laminated strip is covered with at least one thermal insulation coating made of at least one material having a thermal conductivity of less than 0.2 Wm⁻¹K⁻¹.

12. The wheel according to claim 11, wherein the wheel comprises rotating contacts for establishing a rotating electrical connection between the hub of the wheel and the ferrules of the laminated strip.

13. The wheel according to claim 12, wherein the rotating contacts are coupled to electric heating wires which are wound in the thickness of the ferrules of the laminated strip.

14. The wheel according to claim 13, wherein the ferrules of the laminated strip are made of composite material and the interposition layers are composed of a hyperelastic elastomer, the electric heating wires of the laminated strip being embedded in the composite material during the manufacture of the ferrules in order to convey calories to the elastomer making up the interposition layers.

15. The wheel according to claim 14, wherein the electric heating wires are positioned at a neutral fiber in the circumferential direction of the composite material in a plurality of loops circumferentially spaced from each other.

16. The wheel according to claim 13, wherein the electric heating wires run inside a spring one end of which is screwed on the side of the laminated strip onto a collar fastened to a ferrule of the laminated strip containing the electric heating wire, and an opposite end is fastened to the hub.

17. The wheel according to claim 11, wherein the thermal insulation coating is made of one or more of the following materials: synthetic aramid fiber, fiberglass, polyvinyl acetate, and leather.

18. The wheel according to claim 11, wherein the thermal insulation coating is covered under an internal face with a metallic coating to limit the transfer of thermal energy by radiation.

19. The wheel according to claim 11, further comprising a sensor for measuring the temperature of the interposition layers of the laminated strip.

20. The wheel according to claim 11, further comprising Bragg grating optical fibers.
